(19) United States
(12) Patent Application Publication
(10) Pub. No.: US 2014/0125502 A1
(43) Pub. Date: May 8, 2014

(54) SYSTEMS AND METHODS FOR TRACKING VEHICLE OCCUPANTS

(71) Applicants: Jim Wittkop, Huntsville, AL (US); Christopher Gardner, Huntsville, AL (US)

(72) Inventors: Jim Wittkop, Huntsville, AL (US); Christopher Gardner, Huntsville, AL (US)

(21) Appl. No.: 14/073,584

(22) Filed: Nov. 6, 2013

Related U.S. Application Data
(60) Provisional application No. 61/723,656, filed on Nov. 7, 2012.

(51) Int. Cl. G08B 21/22; G08G 1/127

(52) U.S. Cl. CPC G08B 21/22; G08G 1/127
USPC 340/989; 340/573.1; 340/6.1

(57) ABSTRACT

The present disclosure generally pertains to systems and methods for tracking vehicle riders, such as students riding in a school bus, for example. In one embodiment, the disclosed system has a biometric device, such as a palm vein reader, configured to identify users who are expected to ride a school bus. When a student rider either gets on or off the bus, the biometric device is used to identify the rider. An automated controller on the bus maintains a list of expected passengers on the bus, and based on the biometric device, the controller maintains data, referred to hereafter as “rider data,” indicating whether each expected passenger is currently on the bus. The rider data is updated, in real time, as riders get on and off the bus at various stops.

### CROSS REFERENCE TO RELATED APPLICATION

This application claims priority to U.S. Provisional Patent Application No. 61/723,656, entitled “Biometric Tracking Systems and Methods” and filed on Nov. 7, 2012, which is incorporated herein, in its entirety, by reference.

### RELATED ART

In an age of increased concern about traffic congestion and traffic accidents, many persons are anxious when their loved ones are traveling. Parents are especially concerned with the well-being of young children who may not have a means of communication to update their parents regarding their whereabouts and safety when the children are traveling, such as riding in school buses or other vehicles.

Additionally, hundreds of vehicular transportation systems are without a means to notify and allay parent's concerns about their children's transportation. Common concerns from parents often are: 1) whether a child boarded a school bus; 2) whether the child got off the school bus in the proper location; 3) location of the school bus; and 4) the number of remaining children on the school bus.

Thus, a heretofore unaddressed need in the art exists for a more robust communication means that allows users to check or confirm the status of passengers in real time.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts an example hand pattern for one embodiment of the disclosure.

FIGS. 2A and 2B are pictorial diagrams illustrating an example embodiment of a sensing module for use with the hand pattern in FIG. 1.

FIG. 3 depicts an example system diagram of an on-board controller, according to one embodiment of the disclosure.

FIG. 4 depicts an example flowchart for a process for scanning an enrollee using the on-board controller of FIG. 3.

FIG. 5 depicts another example flowchart for using the on-board controller of FIG. 3 to scan a driver.

FIG. 6 depicts an example flowchart for using the on-board controller of FIG. 3 to package rider data.

FIG. 7 depicts an example flowchart for transmitting rider data to a remote server, according to one embodiment of the disclosure.

FIG. 8 depicts an example flowchart for pre-populating the remote server and/or the on-board controller, according to one embodiment of the disclosure.

FIG. 9 depicts an example flowchart for a modified search routine, according to one embodiment of the disclosure.

FIG. 10 depicts an example flowchart for an exit scanning routine, according to one embodiment of the disclosure.

FIG. 11 depicts an example bus route for a plurality of riders.

FIG. 12 depicts an illustrative block diagram illustrating an example server.

FIG. 13 depicts an example graphical user interface (GUI).

### DETAILED DESCRIPTION

The present disclosure generally pertains to systems and methods for tracking riders (e.g., students) of vehicles, such as school buses or vans. In one embodiment, a system has a biometric device, such as a palm vein reader or fingerprint reader, configured to identify users who are expected to ride a school bus. When a student rider either gets on or off the bus, the biometric device is used to identify the rider and track the rider's presence on the bus. A controller on the bus maintains a list of expected passengers for the bus, and based on sensory reading from the biometric device, the controller maintains data, referred to hereafter as “rider data,” that indicates whether each expected passenger is currently on the bus. The rider data is updated, in real time, as riders get on and off the bus at various stops, so that the rider data accurately reflects which riders are currently on the bus.

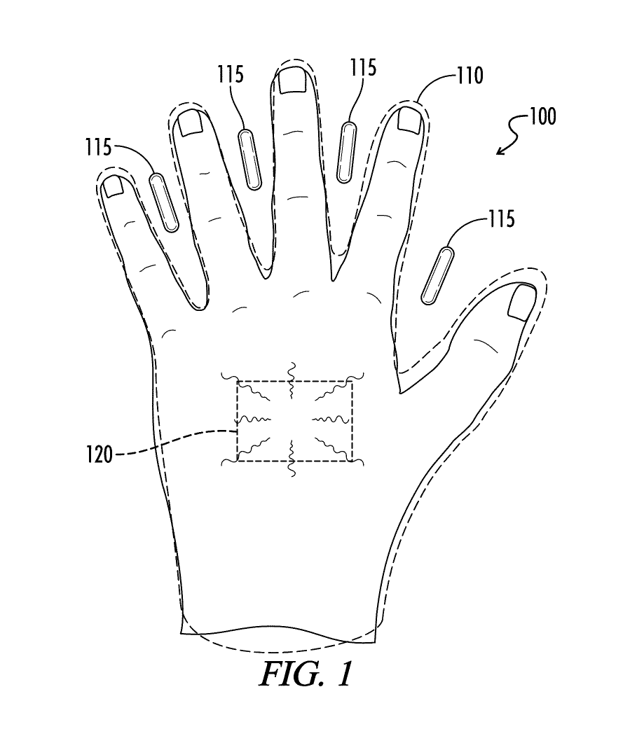

FIG. 1 depicts an example embodiment of a hand guide 100 for aiding the placement of a hand over a biometric sensor 120 (shown as a hidden view beneath the palm portion of the hand guide 100). The hand guide 100 comprises a hand pattern 110 in which a left hand outline is available for a user to align her left hand within the outline. Additionally, the hand guide 100 also comprises one or more alignment aids 115 to further ensure that the placement of a user's hand and fingers will properly align with the biometric sensor 120 located beneath the hand guide 100. The alignment aids 115 may be implemented as fixed posts that separate fingers and properly position said fingers and palm of a person's hand for effective scanning by the biometric sensor 120. Nevertheless, it is contemplated that other alignment aids are possible as well. For example, raised dots or ribs may also be used as the alignment aid 115. In addition, the hand pattern 110 may be lit with light emitting diodes that trace the hand pattern 110. Clearly, the hand pattern 110 may alternatively be a right-handed pattern as well. Moreover, it is contemplated that another type of alignment aid 115 may be better suited or adapted for a different biometric sensor, for example, where the biometric sensor is an iris vein pattern reader, an eyecup or face guide may be preferably suited for ensuring proper alignment with another body part of a person other than a person's hand. The other biometric sensor should preferably be suitable for measuring and analyzing the designated body part, and therefore also perform or operate as a reliable apparatus for identifying a person akin to the palm vein reader of biometric sensor 120 for determining a person's palm vein pattern.

One or more embodiments for monitoring boarding and unboarding of vehicle riders are described in commonly-assigned U.S. Provisional Patent Application No. 61/723, 656, entitled “Biometric Tracking Systems and Methods” and filed on Nov. 7, 2012, which is incorporated herein, in its entirety, by reference.

Various techniques may be used to “read” or sense identifying information from a rider. One disclosed embodiment combines the hand guide 100 with a palm vein reader 200 that is adapted to read unique palm vein patterns from a hand that is proximate or nearby the palm vein reader 200.

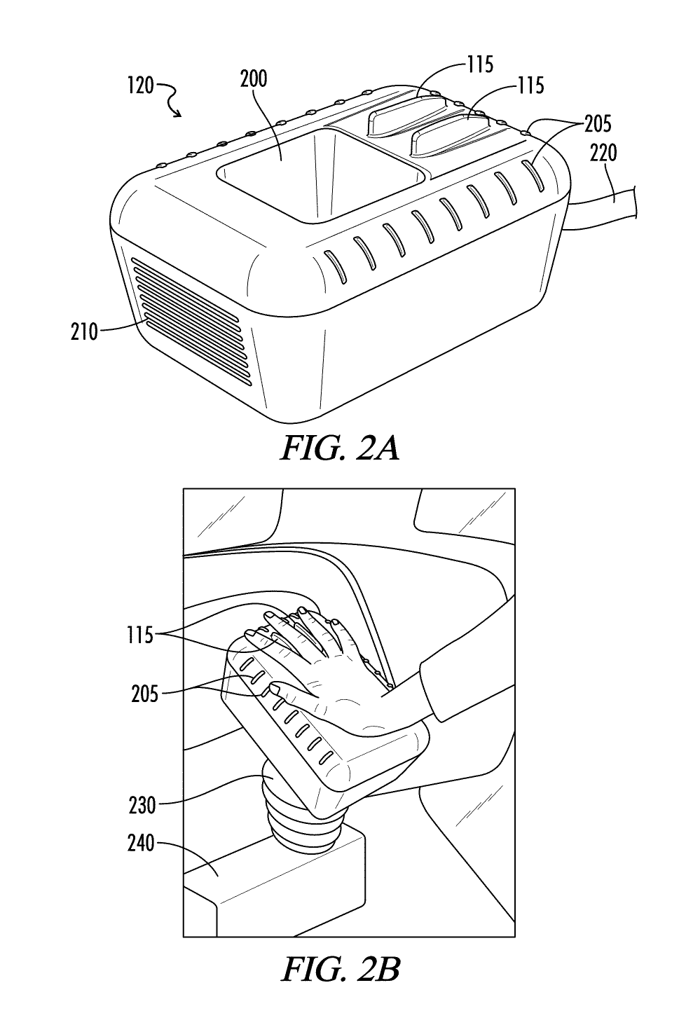

FIG. 2 depicts a pictorial diagram of a biometric sensor 120 that is adapted or configured to read palm vein patterns with a palm vein reader or scanner 200. Specifically, the biometric sensor 120 may be configured to implement vascular pattern authentication technology that is capable of extracting vein pattern information from a nearby hand and generating encrypted numeric vein templates. The palm vein pattern is within a person's hand, which prevents the information from being photographed, traced, or recorded. Thereby, forgery is difficult. The palm vein pattern information includes blood flow through the veins as well as unique, individual vein patterns within a palm.

The palm vein reader 200 may be an “off the shelf” (OTS) item and configured to be adapted to the biometric sensor 120 to authenticate based on active blood flow within palm vein patterns. Notably, palm vein patterns are unique to individuals. The palm vein patterns typically do not change, except in extreme cases of injury or disease, thereby making them a reliable source of authentication information. In operation, a near infrared imager device within the palm vein reader 200 captures a live palm blood vein structure image of a user's palm. As such, the palm vein reader 200 does not require that the palm actually come into contact with the palm vein reader 200 to capture the relevant or corresponding vein pattern. Additionally, while the biometric sensor 120 is described herein as being employed to capture identifying information from palm veins, it is contemplated that the biometric sensor 120 may also be configured to capture identifying information from veins correlated to other body parts, including upper arms, lower legs, and upper legs, for example. Accordingly, the biometric sensor 120 preferably will be capable of capturing identifying information from most or nearly all riders of a vehicular transportation system, regardless of ethnicity, age, physical deformity, or minor skin damage.

The biometric sensor 120, adapted to hold and communicate with palm vein reader 200, further comprises several alignment aids 115 for enabling placement of a hand above the palm vein reader 200. The hand placement may be determined by direction and angular distal relationship of the palm to the palm vein reader 200. Indicator lights 205 provide information regarding user identity and authentication. In addition, the indicator lights 205 may also provide visual information about the operable functionality of the biometric sensor 120. The indicator lights 205 can be light emitting diodes (LED), light emitting fibers, or other similar visible light emitting apparatuses or elements.

The biometric sensor 120 may comprise at least one speaker output 210, which is configured to emanate audible, amplified sounds from the biometric sensor 120. As described later herein, the audible sounds in conjunction with the visible light from indicator lights 205 or solely, on their own, may provide one or more notifications about the operable functionality of the biometric sensor 120 and/or notifications about user identity and authentication. The biometric sensor 120 may be powered externally via power cord 220 or may have an internal source of energy, such as one or more batteries or a solar panel, for example.

FIG. 2B depicts the biometric sensor 120 flexibly attached to a flexible apparatus 230, which is also attached to a support 240. The indicator lights 205 may be positioned around the perimeter of the biometric sensor 120, but can be positioned in another configuration that also provides visibility of the indicator lights 205. In another embodiment, the flexible apparatus 230 may be a fixed rod affixed or attached to support 240. The structure shown in FIG. 2B is contemplated to be easily removable and replaceable in the event the biometric sensor 120 needs maintenance or an upgrade.

Other types of biometric sensors may be suitable for implementation as well, including fingerprint sensors, iris sensors, skin conductance sensors, and facial imaging sensors, for example. In other contemplated embodiments, biometric sensors may substituted with alternative authentication and identification means, including for example, RFID or NFC devices that may be carried by, appended to, or integrated with the vehicle riders.

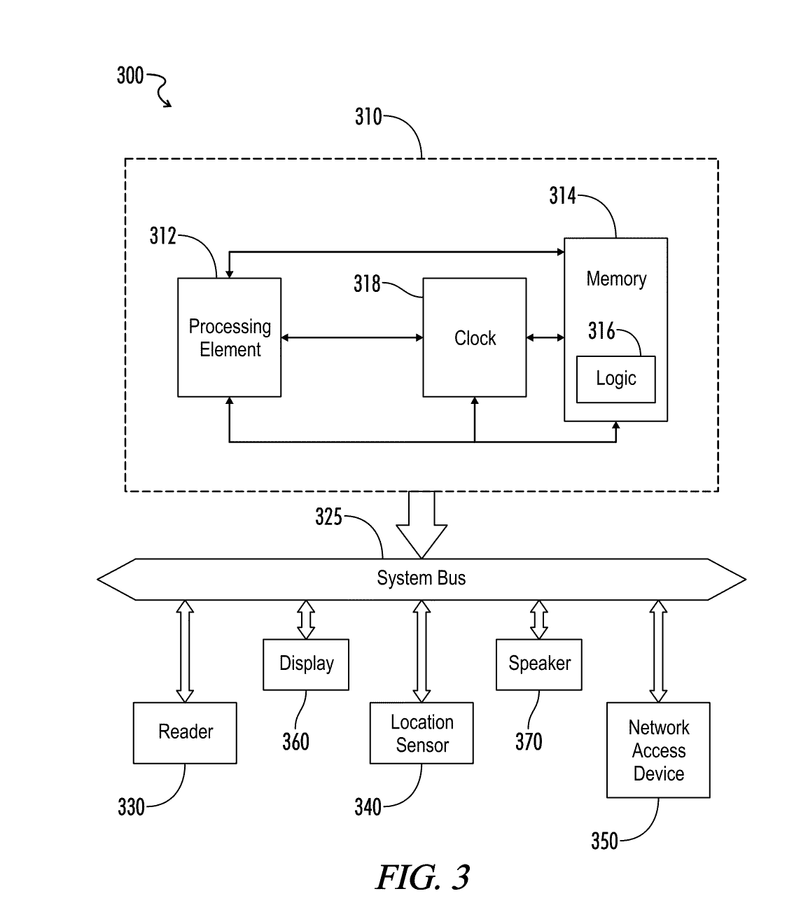

FIG. 3 depicts an example “on-board” controller 300 implemented with a biometric tracking system that may be employed to monitor passengers and other riders of a vehicular transportation system. The on-board biometric controller 300 can be contemplated as being configurable for enabling access control to persons inside or outside of a specific container unit for holding multiple people, such as a bus, train, prison, or a stadium, for example.

The on-board biometric controller (OBC) 300 depicted in FIG. 3 comprises a microcontroller 310 having at least one conventional processing element 312, such as a digital signal processor (DSP) or a central processing unit (CPU) that communicates to and drives the other electronic components within the OBC 300 via a local interface, which can include at least one system bus 325. Alternatively, the OBC 300 can use an application-specific integrated circuit (ASIC) as part of an integrated circuit (IC) or microchip and customized for authenticating vehicle riders. The OBC 300 may also, alternatively, employ field programmable logic gate arrays to accomplish authentication means.

The processing element 312 may be controlled with control logic 316 to accomplish analytical and mathematical tasks for the OBC 300. The control logic 316 can be implemented in software and firmware or any combination thereof. For the example microcontroller 310, illustrated by FIG. 3, the control logic 316 is implemented in software and is stored internal to memory 314 of the microcontroller 310. However, in other embodiments the control logic 316 may be stored external to memory 314 of the microcontroller 310. In this regard, the control logic 316 may also be implemented in hardware, such as ASICs or field programmable logic gate arrays that will enable operations and data transfers for the OBC 300.

Note that the control logic 316, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The microcontroller 310 also includes the memory 314 for storing data related to the operation of the OBC 300. However, the memory 314 need not be limited to an internal location of the microcontroller 310, but the memory 314 may also be external to microcontroller 310 in some embodiments. Specifically, “rider data” about individual riders of the vehicular transportation system may be stored in the memory 314 for quick access and/or retrieval by the OBC 300. Stored rider data may include information about authorized riders or passengers for a specific vehicular transportation system, such as a district-wide school bus system, for example. The stored rider data may also include information about authorized riders for a particular vehicle in operation on a particular day, for example.

Microcontroller 310 also includes a clock 318, which enables time-stamping of the data to be stored in the memory 314. Additionally, clock 318 may be utilized by processing element 312 in cooperation with logic operations as determined by control logic 316 for logical operations requiring time intervals, for example. Likewise, specific mathematical operations may be performed within time intervals based on values generated by the clock 318.

The OBC 300 further comprises a reader 330 for reading or sensing identifying information from a rider. The identifying parameter may be biometric, i.e., measurable information gleaned from a biological element associated with the person. In other embodiments, other types of readers 330 may be used, such as an RFID reader or optical scanner that reads a unique code that identifies the rider. The reader 330 is communicatively coupled to the local interface 325 for communication with microcontroller 310 and its internal components, including processing element 312, control logic 316, and memory 314. The reader 330 is preferably environmentally-sealed in an enclosure to protect it from moisture and dust contaminants. The reader 330 may be further housed in a distinct proprietary housing (shown in FIG. 2A) adapted for adhering the hand guide 100 to the enclosure, wherein for one embodiment, the reader 330, implemented as palm vein reader 200 in FIG. 2A, is positioned below the hand guide 100 for sensing blood vein pattern information from a properly-positioned, nearby “live” hand. Reader 330 should preferably be able to sense the pertinent identifying information through the constructive material of the hand guide 100. For example, a clear acrylic plastic material would allow a near infrared imager to read the blood vein pattern of a live hand or palm.

Additionally, when the reader 330 is implemented as a palm vein reader or scanner 200, the live hand, belonging to the person being scanned, does not actually contact the palm vein reader 200 (depicted in FIG. 2A). The OBC 300 employs a randomly encrypted scheme for the acquired palm scan data. Another security measure, especially inherent to the OBC 300, is that continuous third party tracking of riders is frustrated, because the digitized palm scan information, for example, is not continuously with the rider during the course of his day, once he exits the vehicle. In sharp contrast, RFID tracking of RFID tags that are worn on lanyards or attached to school bags allow for continuous tracking of the student's movements throughout the day. This may be problematic where the RFID tracking means is in the hands of an unauthorized individual.

A display 360, also communicatively coupled within OBC 300 via system bus 325, provides a visual cue of the operation of OBC 300 based on sensory imaging from the reader 330. The display 360 may comprise a display screen (e.g., an LCD or OLED display screen), or alternatively may comprise a bank of different colored LEDs, for example. In one embodiment, a sequence of LEDs may be combined with a display screen for indicating authentication information based on sensory readings of the reader 330 and rider data stored in memory 314, for example. Pre-determined colors or graphics for display 360 may indicate whether a rider that is boarding a vehicle is authorized to do so. Moreover, the bank of LEDs may be enclosed within the special housing for the OBC 300. The bank of LEDs can be on one or more strips and may also be positioned around the perimeter of the proprietary housing of the OBC 300.

Similarly, authorization notification may be accomplished via audible means through a speaker 370. In this regard, predetermined sounds may be used to indicate whether a rider that is boarding a vehicle is authorized to do so. Additionally, the audible sounds from speaker 370 may be combined with the visual cues displayed on display screen 360 to provide an enhanced notification to the driver of the vehicle, for example.

Time-stamping of the rider data in memory 314 may be augmented with location data provided by a location or positioning sensor 340, such as a GPS sensor, for example. Location sensor 340 receives satellite positioning data or other type of positioning data (e.g., WiFi data) to aid in determining the location of a particular vehicle. Each vehicle may be assigned a particular route or routes to travel in order to provide transportation to a designated group of riders. The assignment, termed a “vehicle assignment,” may be done, for example, in advance of a certain calendar event or period, such as the start of a school semester or year. Alternatively, in one embodiment multiple vehicle assignments may be assigned daily for a fleet of vehicles, for example. An individual vehicle assignment may include a particular route and a list of riders positioned along the particular route.

Geographical coordinates, acquired from location sensor 340, such as latitude and longitude, may be analyzed by processing element 312 to determine whether the vehicle transporting the riders is on the correct assigned route according to a vehicle assignment for the vehicle. In one embodiment, the processing element 312 may determine in real time whether the vehicle has been stationary for a prolonged period of time by dynamically analyzing the geographical coordinates and/or other location data from location sensor 340. The location data may also be combined with biometric information about specific riders, either boarding or unboarding the vehicle. That is, once a rider is “scanned” by reader 330, which may be implemented as biometric sensor 120, the biometric data may be read from the rider during a scanning process. The controller 310 acknowledges and authorizes the rider to embark with the vehicle. The processing element 312 enables the exact location where the rider boarded the vehicle (as gleaned from location sensor 340) to be appended to the time-stamped biometric data about the rider. Therefore, the location and time of boarding by the authorized rider may be captured and subsequently stored in memory 314 for further use, such as notifying an administrator or concerned individual about the status of the rider. Accordingly, a list of passengers may be built from the stored rider data. In this regard, each scan by reader 330 results in an incremental compilation of a passenger list in memory 314 that may be analyzed and further manipulated to provide assessment about the presence of one or more individuals or groups of riders.

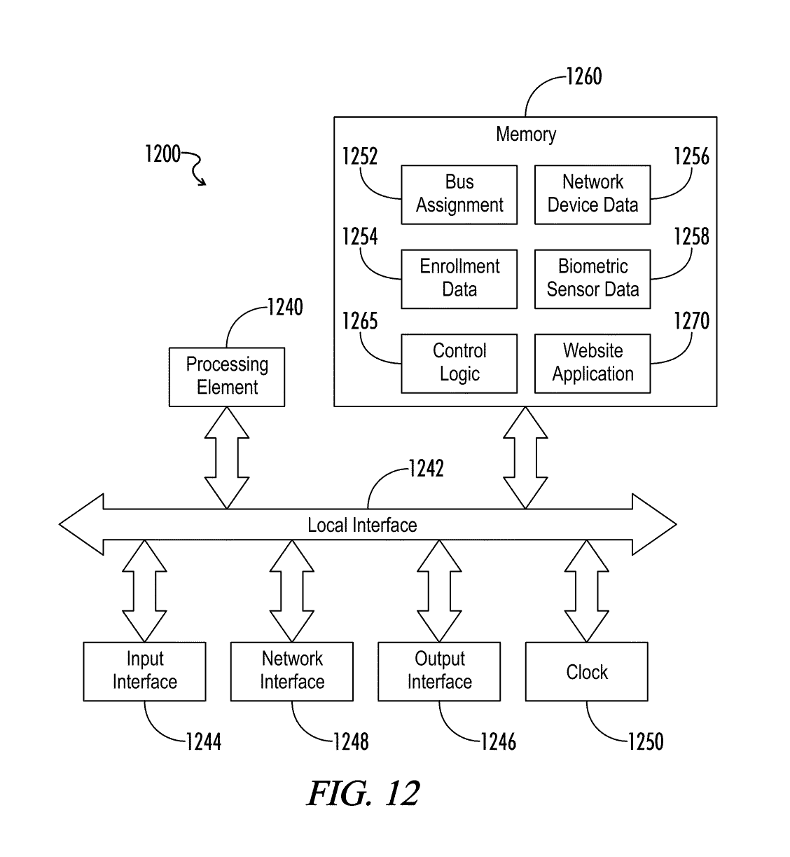

The OBC 300 also includes a wireless network communication access device 350 (e.g., a cellular transceiver or WiFi transceiver) for enabling the OBC 300 to wirelessly communicate with other wireless devices over an external network, such as the Internet (using TCP/IP protocol, for example) or a cellular network (using 3G or 4G LTE, for example). Wireless network communication access device 350 should preferably enable a remote communication and/or computing device that is apart and separated by an extended geographical distance from the OBC 300, such as a server 1200 (shown in FIG. 12). The server 1200 is preferably not positioned in the vehicle with the OBC 300; and thus is defined as apart and remote from the OBC 300. Consequently, the remote server 1200 is communicatively coupled to the OBC 300 for transmission and reception of data. Additionally, the remote server 1200 may be further configured to host a website that permits authorized users to access the stored rider data from the remote server 1200. Accordingly, the status of each scanned rider can be accessed in real time via a connected server 1200 communicatively coupled to the wireless network communication access device 350.

In one embodiment, an identity match of a rider can logically be assessed by OBC 300 and also at remote server 1200 using control logic 316 and control logic 1265, respectively. When the control logic 316 of the OBC 300 conducts an identity match, the network access device 350 may transmit to the remote server 1200 information about the identity of the rider, scan timestamp, transmission timestamp, and type of scan to indicate whether rider boarded or disembarked from the vehicle.

A recently suspended or otherwise disciplined rider has lost their riding privileges due to a disciplinary revocation action. The remote server 1200 can be updated with this ridership discipline information and can further transmit the ridership discipline information to the OBC 300 for use as a means to alter the route of the vehicle, thus enabling the control logic 316 in cooperation with location sensor 340 to cause the display 360 to inform the vehicle's driver to drive pass a particular vehicle stop, because the vehicle stop is at least temporarily non-approved due to the recent ridership discipline information impacting the disciplined rider, who normally boards the vehicle at said vehicle stop. Additionally, the ridership discipline information may also be used to deny the disciplined rider access to the vehicle.

In another example scenario, in which the OBC 300 is implemented on board a school bus, an administrator or other authorized user can access an Internet website that is hosted by the server 1200 to determine whether a particular child is currently on the bus. The Internet website may also graphically indicate the current location of the bus via location data determined from the location sensor 340. The location data may be translated from longitude and latitude values to a graphical depiction of the route traveled by the vehicle. Therefore, the authorized user can discover whether the child boarded the school bus earlier in the day and, if so, the time and place where the child boarded the bus as well as the time and place where the child disembarked from the bus.

Consequently on the example school bus, the rider data, based on the location data and passengers scans with reader 330 (in some cases implemented as a biometric sensor), can be analyzed at any time to determine which passengers are currently on the bus. Such analytical information can be useful for a variety of reasons. For example, in the event of an accident, the rider data can be analyzed to determine which passengers were riding the bus at the time of the accident. In another example, if one of the passengers is missing (e.g., does not reach home after getting off the bus), the rider data can be analyzed to determine whether the passenger boarded the bus and, if so, when and where the rider exited the bus. In other embodiments, there may be various other usages of the rider data.

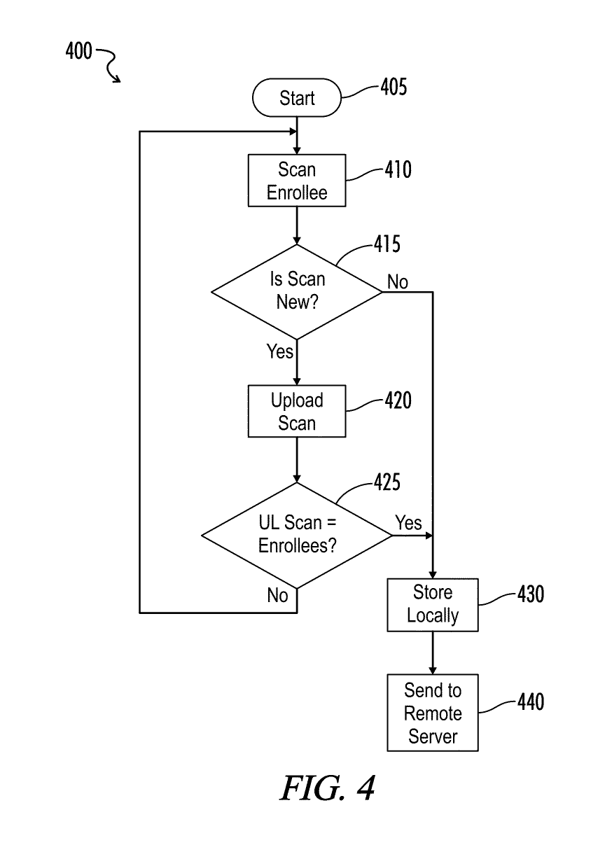

FIG. 4 depicts an example flowchart 400 for acquiring initial rider data for comparison with the real time rider data produced by the OBC 300. An initial operation 405 starts the acquisition or capture of scan data by the reader 330, which in some cases is a biometric sensor and in other cases is an NFC sensor, for example. A scanning operation 410 ensues, whereby an enrollee scans her scanning device or actual body part, such as a hand, within a distance proximate or nearby to the reader 330. In one embodiment, wherein the reader 330 is a palm sensor 120 capable of reading a palm vein pattern, the enrollee places her hand in a hand guide 100 for proper alignment with reader 330. The control logic 316 determines in operation 415 whether the recent enrollee scan is new by comparing the recent enrollee scan to a previously stored scan in either the memory 314 or at the server 1200. In one embodiment, the previously stored scan at the server 1200, for example, may have been stored during an earlier enrollment/registration period comprising vehicle assignment for transportation services to potential riders. In another embodiment, the previously stored scan in memory 314, for example, may have been stored at least prior to boarding of the vehicle. If the enrollee scan is determined to be new, then operation 420 uploads the enrollee scan to a server 1200 for the vehicle transportation authority or school district, for example. In any event, the enrollee or enrollment scan data may include biometric information, scan device information, and name of each rider expected to ride one or more transportation vehicles during a designated time period and a given route, for example.

A second inquiry or determination operation performed by control logic 316, operation 425, inquires whether the uploaded scan is an authorized enrollee. If not, the system allows for a new enrollee to be scanned. If operation 425 determines that the uploaded scan is of an authorized enrollee, then the uploaded scan is also stored locally within memory 314 of the OBC 300 per operation 430. The same uploaded scan is also sent via operation 440 to a remote server 1200, operating as part of a cloud network, for storage and retrieval.

The uploaded data information in the cloud network is compared with the OBC 300 to determine any changes to the data. For example, if the remote server had a record of new palm vein structure data, then that record would indicate an additional scan exists for an additional person. Likewise, new enrollee information regarding a corresponding vehicle assignment at the remote server 1200 would be assessed and compared by control logic 316 with the record in memory 314 of OBC 300 regarding a vehicle assignment for a new rider.

Accordingly, assume that a hypothetical rider, Jane boards the bus on which the OBC 300 resides. Jane scans her palm, using reader 330, implemented as palm sensor 120. The reader 330, itself, does not retain any of Jane's scanned biometric information. The scanned palm vein structure becomes a digitized signature. The digital signature is authenticated against enrollment data that was procured in the same biometric scanning fashion, as described with reference to FIG. 4 and flowchart 400. At the start of the route, the onboard system, OBC 300, from the cloud network and remote server 1200 the enrollment data for the riders that are assigned to the bus for the current route. After Jane's palm is scanned, the control logic 316 determines whether the scan is recognized. The OBC 300 authenticates rider Jane. The exact location, from location sensor 340, where Jane boarded the vehicle will be appended to the time-stamped biometric data about Jane by processing element 312. Therefore, the location and time of boarding by authorized riders may be captured and subsequently stored for transmission to the remote server 1200. The above described passenger list may be transmitted in whole to the remote server 1200.

Jane's scanned biometric information is pushed to the remote server 1200 to allow real time notification that the scanned passenger, Jane, was identified as being on the vehicle. Such notification includes the time that Jane scanned her palm when boarding the bus and the location of the bus at such time the scan ensued. Additional information may also be sent to the remote server 1200, including the current location of the vehicle and data related to other passengers on the vehicle. The additional information may be acquired from other sensors on or communicatively coupled to the vehicle. For example, in one embodiment, the location sensor 340 can provide vehicle speed and vehicle route information to the remote server 1200, because of dynamically changing position or location data as sensed by location sensor 340.

OBC 300 (FIG. 3) includes a historical reporting component for keeping track of each rider's scanning history. At the remote server 1200 (FIG. 12), vehicle assignment information and a list of authorized riders for the particular day and time are stored and updated. The remote server 1200 is aware of its updated records and the OBC 300 is aware of its own updated records. Consequently, a comparison of data records stored within the two systems ensues in an ongoing communication between the remote server 1200 and the OBC 300. In one example embodiment, the control logic 316 compares data records found in the OBC 300 with data records found in the remote server 1200 based on recognized timestamps developed from clock 318 and clock 1250, respectively. The comparison enables control logic 316 and control logic 1265 to determine the latest or most recent data records.

The data records may include a vehicle assignment to a particular school and vehicle rider registration with a particular school, along with palm vein pattern data correlated to the vehicle rider. The data records may also be configurable to an end user's requirements for handling and presenting data relating to the rider.

In one embodiment, a driver initializes or powers-up the OBC 300 at a starting location point by starting her vehicle. She then scans her own palm at palm sensor 120 before beginning her route. During the route, as riders board the vehicle, each rider scans his or her palm at palm sensor 120, for example, to enter his or her ridership into the OBC 300. A timestamp of the scan for the particular rider is also captured by clock 318 and stored in memory 314. The location sensor 340 determines the location and position of the vehicle. The location data may be in the form of latitude and longitude, but need not be so limited. In this regard, the vehicle's location data can be correlated with the rider's scan. The location data may be appended and combined to the timestamp and palm scan data, according to control logic 316, as a data package relevant to a particular rider. This combined data package may be considered “rider data.”

While the vehicle is stopped to allow riders to either board or leave the vehicle, the control logic 316 of OBC 300, using location data from location sensor 340, recognizes that the location of the vehicle has not changed. Therefore, the control logic 316 recognizes that a predetermined threshold for vehicle speed has not been met or exceeded and causes microcontroller 310 to prevent transmission and reception of data from the network access device 350 of OBC 300 to the remote server 1200 while the vehicle remains stopped. Instead, the rider data is retained in the memory 314. This methodology postpones transmission of rider data and other correlated authorization data to the remote server 1200 until the vehicle begins moving. Preferably, the delayed transmission of rider data, for example, does not affect any scanning process that may be occurring on the vehicle. In particular, automated processing resources related to processing element 312, for example, are conserved during the vehicle stop by the delayed transmission of the rider data or other authorization data. Having the rider data stored locally within the memory 314 of OBC 300 also advantageously aids in reducing bottlenecks of riders waiting needlessly long minutes outside of the vehicle during boarding. In this regard, the rider data can be stored locally in memory 314 and need not immediately be sent to a remote server 1200, thus enabling faster scans. However, other data may still be transmitted to the remote server 1200 from OBC 300, while the rider data is postponed.

The memory 314 of OBC 300 includes enrollment data and vehicle assignment information. The vehicle assignment information may include an assigned route or routes that the vehicle may travel in order to provide transportation to a designated group of riders. The assigned route, termed a “vehicle assignment,” may be done, for example, in advance of a certain calendar event or period, such as the start of a school semester or year. Alternatively, in one embodiment multiple vehicle assignments may be assigned daily for a fleet of vehicles, for example. An individual vehicle assignment may include a particular route and a list of riders positioned along the particular route. In one embodiment, the vehicle assignment may be pre-matched with stored biometric scan data or other authorization data from reader 330 for the expected riders.

Network access device 350 enables transmission and reception of information, such as palm vein pattern scan data, for example, from the OBC 300 to the remote server 1200 and vice versa. However, control logic 316 may be configured to assess whether the vehicle moves a predetermined distance, for example 100 meters from a vehicle stop, before allowing the network access device 350 to transmit scan data from the OBC 300 to the remote server 1200. In another embodiment, the OBC 300 may update the remote server 1200 with its new information, according to control logic 316, when the vehicle travels above a predetermined speed threshold, as determined by location sensor 340, for example. The speed threshold may be preferably set by control logic 316 to allow for small speed deviations and still account for the vehicle's movement. For example, the speed threshold can be set to account for small vehicular movement related to slow-moving traffic conditions.

Nevertheless, in another embodiment the network access device 350 may be configured to allow transmission of rider data at any time, including when the vehicle is stopped or when the vehicle has not exceeded a predetermined speed threshold.

In one example embodiment, the memory 314 retains the rider data at the OBC 300, if signal reception for a cellular network or WiFi network is weak. In this regard, control logic 316 analyzes an available cellular or WiFi signal strength indicator and determines when to communicate with the remote server 1200, based on the signal strength indicator. Where cellular network or WiFi network coverage is available and strong, as reflected by the signal strength indicator, a transmission or push from the OBC 300 to the remote server 1200 occurs, if the vehicle is above the speed threshold. The remote server 1200 sends a return acknowledgement to the OBC 300. In one embodiment, the OBC 300 serially sends each updated rider data record, during a push, to the remote server 1200, if an appropriate amount of signal strength corresponding to the cellular or WiFi network exists. After each push, the OBC 300 re-verifies connectivity to the cellular or WiFi network as well as re-verification of completed transmission to the remote server. In one example, the remote server 1200 may send a single bit indication, labeled as a true flag, for example, to indicate that the transmission or push was successful. In contrast, the remote server 1200 may send a false flag where the transmission or push was unsuccessfully processed or incomplete. A third scenario may involve the remote server 1200 unable to send either a true or false flag within a defined time period. The network access device 350 of OBC 300 may be configured by control logic 316 to attempt another transmission or push of rider data if an acknowledgement is not received from the remote server 1200 within a defined time period. In this last regard, the remote server 1200 waits for a later transmission or push attempt by the OBC 300.

When the transmission or push of a data record to the remote server 1200 from the OBC 300 succeeds, and the remote server 1200 sends a true flag to the OBC 300, the OBC 300 may delete or scrub that particular stored data record in memory 314. Thus, the OBC 300 retains each record in memory 314, until it is confirmed that the record has been successfully updated and stored on the remote server 1200. Removal of the record at the OBC 300 helps to ensure that the biometric information is not compromised in the event that an unauthorized user gains access to the OBC 300. However, in some embodiments, a portion of the record may be scrubbed, such as the passenger list reflected by the passengers' biometric information, while other data, such as vehicle location data, for example, may be retained.

At a destination point, riders scan again when they exit the vehicle. These exit scans by riders result in incrementally reducing the passenger list that was recorded in memory 314 of the OBC 300 as riders boarded the vehicle. Thus, with each successful exit scan, the passenger list is reduced by one, until no passengers are left in or on the vehicle as evidenced by a totality or aggregation of the exit scan. The driver may perform a physical check of the interior of the vehicle to confirm that all passengers have exited the vehicle and that the OBC 300 is accurate with respect to the totality of exit scans showing that the vehicle is empty, except for the driver herself. Indications or notifications, as described in one embodiment herein, are available to alert the driver when one or more passengers may be unaccounted for and are recorded as not having left the vehicle. Such an indication can occur after a drive provides input indicating that disembarking by the passengers is complete, but at least one passenger has not been removed from the passenger list, based on the exit scan One optional policy may allow the driver to override an electronic indication or notification, provided by the OBC 300, of a rider still remaining on the vehicle; if the driver conducts a physical examination of the vehicle's interior.

A rider may unwittingly leave the vehicle, assuming the OBC 300 accepted his scan as a successful exit scan. An “accepted” scan for the OBC 300 provides enough scan data from reader 330 for the processing element 312 to analyze and affirm identity and authorization of a rider according to control logic 316. An “unacceptable” scan does not provide enough scan data for the processing element 312 to analyze and affirm identity and authorization of a rider according to control logic 316. Impairment of the biometric sensor 120 or of the scanned apparatus, in the case of an RFID or NFC device may, for example produce an unacceptable scan for the OBC 300. The determination of an acceptable scan by the control logic 316 may also employ stored rider data in memory 314 to aid the processing element 312.

A visual cue may aid driver and rider in recognizing that a scan at the OBC 300 is deemed acceptable. The visual cue may include differently displayed colored lights, or graphical notations, or animations via display 360 for indicating an acceptable scan versus an unacceptable scan; as determined by the control logic 316 for the OBC 300. The correlation of the scans corresponding to the rider's identity are determined as “accepted” or “unaccepted” in part due to the initial enrollment data stored in the remote server 1200. That is, the control logic 316 compares rider data inputted to the OBC 300 and scan data inputted at initial enrollment or registration for an authorized population of riders. Thereby, the control logic 316 provides a means to accept or deny acceptance of the scanned data received at the OBC 300. In one embodiment, the control logic 316 provides a threshold for the processing element 312 to assess received data points associated with the rider data in order to determine efficacy and coherence of the rider data as well as accuracy of the rider data, when compared to the initial enrollment or registration data for the authorized population of riders.

However, a new rider may not have been properly registered for the particular vehicle and yet attempts to ride in the vehicle. That rider's scan may be registered by the OBC 300 as an unacceptable scan. In one embodiment, the aggregation of unacceptable scans is reported by the OBC 300 to the remote server for further attention by authorities.

The combination of displayed LED colors on display 360, for example, allows for multiple visual cues based on analysis of rider data by control logic 316. In an example embodiment, a rider who has been suspended from riding in the vehicle may be recognized as a non-authorized rider, as a result of interpretation of her scan by control logic 316, along with comparison of enrollment scan data stored at the remote server 1200. That is, control logic 316 retrieves enrollment scan data of the population of authorized riders from remote server 1200 or in some instances, retrieve the same enrollment scan data from internal or communicatively coupled memory 314 of the OBC 300. The control logic 316 may compare the scan data from the OBC 300 to the retrieved enrollment scan data. The comparison may comprise data sufficiency thresholds and other means for ensuring the accuracy of the resulting data comparison. Control logic 316 compares, interprets, and analyzes the scan data, before accepting the scan data and therefore confirming authorization of the rider to board the vehicle or before denying acceptance of the scan data and rejecting authorization of the rider to board the vehicle. In the case of a rider that previously was an authorized rider at the start of an enrollment period, for example, subsequent associated ridership suspension information may be used by official personnel to update remote server 1200 in advance of the control logic 316 of OBC 300 performing its comparison check against information at the remote server 1200.

In one example embodiment, the remote server 1200 retains a passenger list that includes suspended riders and their current suspension status. Hence, the OBC 300 and the remote server 1200 cooperatively can recognize a scan of a suspended rider.

A specific instant visual feedback for classification of this particular vehicle suspension is contemplated herein. For example, a particular colored LED, such as blue, may be used to indicated a non-authorized or suspended rider. Likewise another LED color, such as green, may be used to provide instant visual feedback of a proper push or transmission of the rider's scan to the remote server 1200. Whereas another color, such as red, for example, may be used as an indicator that the rider's scan was not accepted or properly read by the sensor 120. In addition, two or more colors may be combined to provide indication of a malfunctioning OBC 300. Thus, real time feedback, at the vehicle, to vehicle riders and the driver is possible.

In another embodiment, the instant visual feedback may either be substituted with an audible feedback or may complement the instant visual feedback. In this regard, one or more speakers 370 are employed within the housing for the OBC 300 to produce audible sounds. The audible sounds may be designated to indicate an acceptable scan versus an unacceptable scan. Alternatively, the audible sound may indicate operational functions and malfunction of the OBC 300. In one embodiment, a predetermined audible sound from speaker 370 of the OBC 300, such as a continuous ringing tone, for example, may indicate a successful push or transmission of rider data from the OBC 300 to the remote server 1200. Whereas, another predetermined audible sound from the speaker 370, such as a buzzing sound, for example, may indicate an unsuccessful push of rider data from the OBC 300 to the remote server 1200. Likewise, a third distinct audible sound, such as a wooden stair creaking may be designated, for example, to indicate that OBC 300 has malfunctioned, for example.

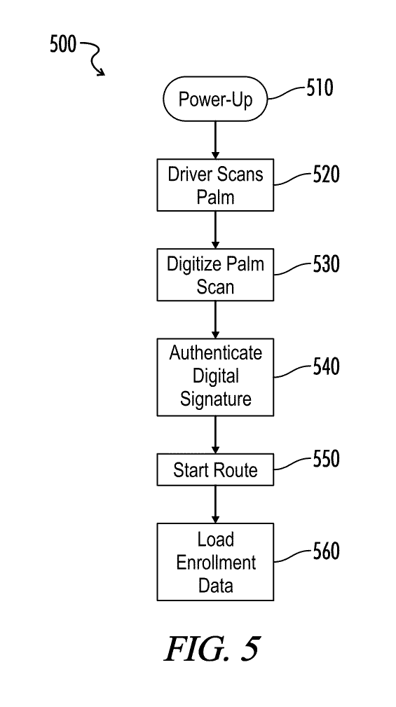

FIG. 5 depicts a flowchart 500 for illustratively describing an example process regarding a driver responsible for picking up schoolchildren on an assigned school vehicle route. The vehicle may be a bus or small SUV or other vehicular passenger apparatus configured for transporting students traveling to a facility. At the bus yard where the driver begins his route, the driver initializes (510) the OBC 300 by starting his vehicle's engine. The driver scans (520) his own palm with the reader 330, implemented as a palm sensor 120. The reader 330 digitizes (530) the driver's palm scan. There is no retention of the driver's palm scan by the reader 330. The control logic 316 authenticates (540) the digital signature correlated to the driver's palm scan by comparing the driver's palm scan to system scan data corresponding to all registered and previously approved drivers. The system scan data can be downloaded to the OBC 300 from the remote server 1200 in order to determine that the driver has permission to operate the vehicle. Upon the control logic 316 authenticating the driver's palm scan, the driver starts driving (550) the assigned route to pick up the schoolchildren that are assigned to his vehicle. However, if the processing element 312 and control logic 316 determines the driver's palm scan as unauthorized, the vehicle's operation may be disabled via prevention of engine ignition. Alternatively, in one embodiment, the OBC 300 when operatively coupled to the vehicle's controller system may prevent transmission of a required software bit to the vehicle controller in order to disable operation of the vehicle. At the beginning of the route, as the vehicle surpasses a speed threshold, the remote server 1200 transmits (560) enrollment scan data pertaining to the assigned schoolchildren to the OBC 300. As stated earlier, the enrollment scan data can include the name of each student expected to ride the vehicle for the current route and corresponding registration data for each student.

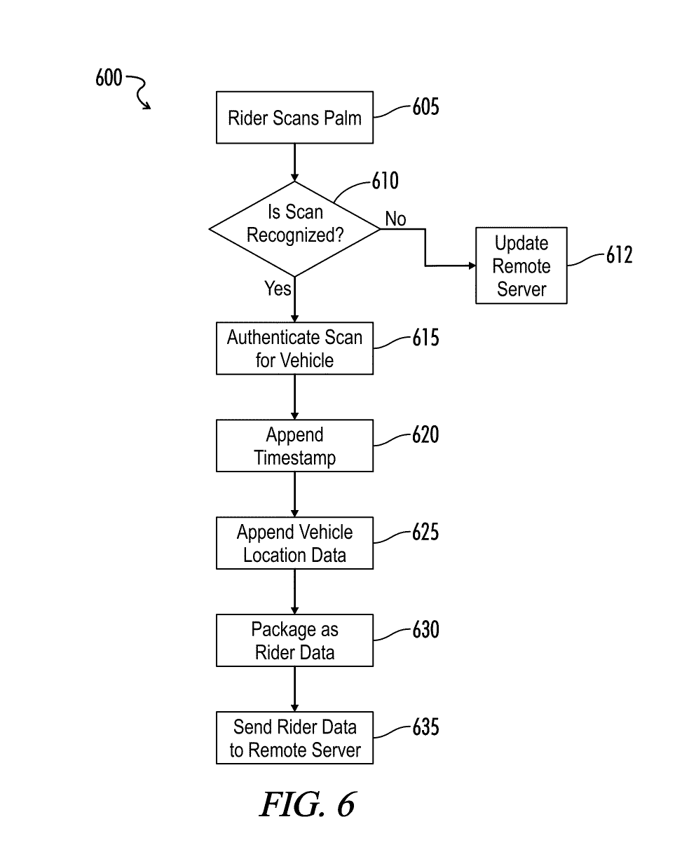

FIG. 6 depicts a flowchart 600 for illustratively describing an example process regarding riders boarding a vehicle designated for transporting them to a facility. In one embodiment, the riders are schoolchildren who have previously provided an initial palm scan during their enrollment and/or registration with their school. The initial palm scan data becomes a digitized signature, and the remote server stores the digital signature per each enrollee of the school. Thereafter, on the morning bus route, for example, as a rider boards the bus, the rider scans (605) her palm into the OBC 300. The control logic 316 compares the rider's palm scan to the enrollment scan data, downloaded to the OBC 300 from the remote server 1200, in order to determine whether the rider's palm scan is recognized (610) as an authorized rider. If the rider is recognized as an authorized rider, the control logic 316 authenticates (615) the rider's palm scan as an assigned rider for that particular vehicle. If the rider's palm scan is not recognized 610 as an authorized rider, the control logic 316 updates (612) the remote server 1200, via the network access device 350, with the rider's palm scan for further assessment.

Upon authentication, the control logic 316 appends (620) the rider's palm scan with a timestamp developed from clock 318. Similarly, the control logic 316 also appends (620) the rider's palm scan with location data of the vehicle from location sensor 340 that may initially be in the form of latitude and longitude location coordinates or points before a positioning translation occurs. The control logic 316 packages (630) the rider's digitized palm scan, appended to a timestamp and vehicle location data, referred to as “rider data.” Thereafter, the network access device 350 transmits (635) the packaged rider data to the remote server 1200. In some cases, this transmission of rider data from the OBC 300 to the remote server 1200 is referred to as a “push.” In other embodiments, the rider data may include other types of rider information, such as gender, disabilities, and seating preferences, for example.

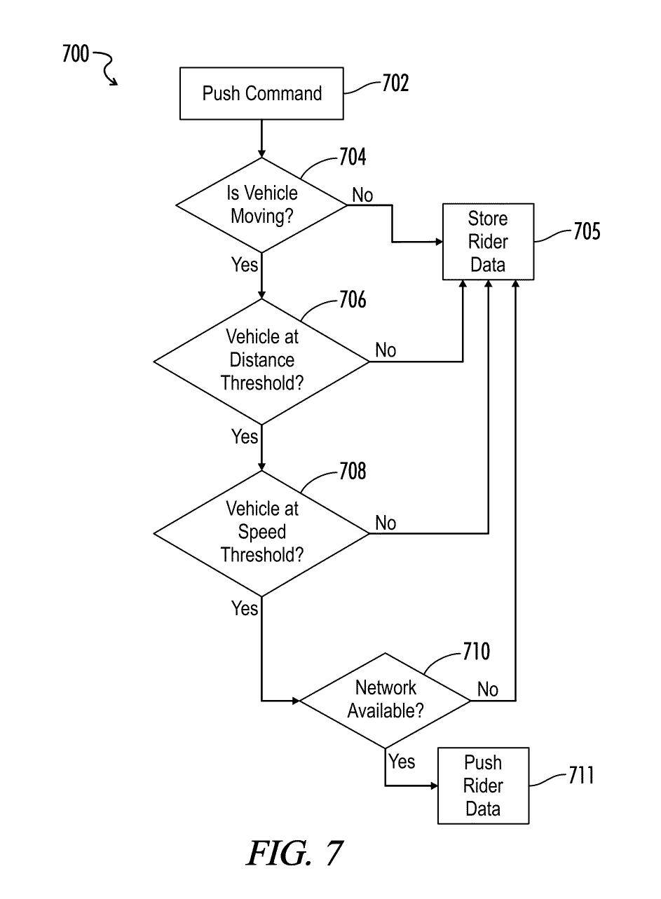

FIG. 7 depicts a flowchart 700 for illustratively describing an example process regarding transmission of rider data from the OBC 300 to a remote server 1200. The remote server 1200 may be part of a larger cloud network, but need not be so limited. Network access device 350 receives (702) a push instruction from control logic 316, informing the OBC 300 that the rider data is ready for sending or transmitting to the remote server 1200. However, for efficient transmission of the rider data, certain criteria, according to control logic 316, should preferably be met. For example, processing element 312 determines (704) whether the vehicle having the OBC 300 is moving, based on receipt of its location data from location sensor 340. If the processing element 312 determines (704) the vehicle is moving, the processing element 312 further determines (706) whether the vehicle reaches a distance threshold. Upon the vehicle reaching the distance threshold, the processing element 312 determines (708) whether the vehicle reaches a predetermined speed threshold set in control logic 316.

Before the network access device 350 transmits the rider data, the processing element 312 determines (710) whether there is a network available and suitable network signal strength for handling rider data transmission. Acceptable networks may be, for example, a cellular network or a WiFi network. When the processing element 312 determines (710) an available network exists, the network access device 350 pushes (711) the rider data to the remote server 1200. In the event any of the aforementioned determinations by processing element 312 is insufficient, the control logic 316 instructs the network access device 350 to refrain from transmitting the rider data to the remote server 1200. Instead, the control logic 316 causes the memory 314 to store (705) the rider data locally at the OBC 300 of the vehicle. The control logic 316 retrieves the rider data and sends it to the network access device 350. The network access device 350, may subsequently transmit the rider data at a later moment in time to the remote server 1200.

Therefore, when the control logic 316 determines (704) that the vehicle is not moving, i.e., the vehicle is at least temporarily stationary, the control logic 316 causes the memory 314 to store (705) the rider data, and the network access device temporarily prevents transmission of the rider data to the remote server 1200. That is, the OBC 300 delays transmission of the rider data to the remote server 1200. Likewise, where the control logic 316 determines that the vehicle has not traveled beyond the predetermined distance threshold, the control logic 316 causes the memory 314 to store (705) the rider data and delay transmission of the rider data to the remote server 1200. In a final check, the processing element 312 determines whether the vehicle's velocity meets a speed threshold. If the vehicle velocity fails to meet the speed threshold, the control logic 316 causes the memory 314 to store (705) the rider data and delay transmission of the rider data to the remote server 1200. The network access device 350 transmits externally from the vehicle, when an available network exists; if no network is available, the control logic 316 causes the memory 314 to store (705) the rider data and delay transmission of the rider data to the remote server 1200.

The local storing of the rider data in memory 314 of the OBC 300 also allows for retention of data, if cellular network or WiFi network coverage is spotty. Where cellular network or WiFi network coverage is available and strong, the network access device 350 transmits or pushes the rider data from the OBC 300 to the remote server 1200 (FIG. 12), if the vehicle is traveling above the speed threshold.

The remote server 1200 transmits a return acknowledgement to the OBC 300, after receiving each packet of the rider data. Network access device 350 receives an indication or acknowledgement from the remote server 1200 that the transmission or push was successful. Thereafter, OBC 300 may delete or purge that particular stored record in memory 314, because the rider data has been successfully updated and stored on the remote server 1200. Therefore, in one embodiment, once the rider data for a given student is transmitted to the remote server 1200, the rider data associated with that student can be stored elsewhere other than directly at the OBC 300.

In other embodiments, some scan searching features, implemented by the OBC 300, may be modified for specially-assigned routes on particular days. For example, in the case of using the OBC 300 within a city-wide school system, the OBC 300 scan searching may be modified with control logic 316 for a day long field trip (as part of a scheduled travel itinerary) that utilizes multiple buses, wherein each bus has at least one assigned OBC 300. The OBC 300 may be modified with a single input such as a switch or touch screen input to change its operational mode from normal bus route to a field trip operational mode, for example. In the field trip operational mode, the processing element 312 conducts scan searching of stored digitized scans of students attending the field trip, as well as stored bus assignments for the trip attendees. The digitized scans of students attending the field trip and their relevant bus assignments may be stored in memory 314 or at the remoter server 1200. The control logic 316, compares the scans received at the OBC 300 with the stored digital scans for the list of students attending the field trip. The processing element 312 assesses the scans for authorization to ride one of the multiple buses available for the field trip. When the rider's scan is authorized, the processing element 312 provides a signal to the display 360 to indicate said authorization of the rider. The control logic 316 may further parse the authorization assessment and inquire which specific available bus the rider is assigned to.

Accordingly, the stored scan data may comprise an identifier of an authorized field trip attendee, a vehicle or bus assignment, and digitized scan information that can, for example, include alternatively palm vein patterns, RFID data, NFC data, iris vein patterns, and fingerprint patterns as identification means to uniquely identify the rider. The control logic 316 can use the stored scan data to affirm how many riders return to the vehicle after a vehicle stop at a designated field trip location. The processing element 312 may include a counter for tracking numbers of scans during embarking and disembarking. The control logic 316 may cause the display 360 of OBC 300 to change in a manner that informs the driver of the vehicle of a disparity in numbers of riders that have been accounted for. For example, a warning message may be displayed on display 360 or a combination of LED lights affixed to the housing of OBC 300 may be activated to warn the driver of a possible miscount of the riders. That is a count of x-riders scanned during embarking is not equivalent to a count of y-riders scanned during disembarking, thus resulting in a miscount or number disparity corresponding to the number of scanned riders aboard the vehicle.

In one embodiment, the control logic 316 may count the number of scans detected by reader 330 as students board the bus for the field trip. In doing so, a list of students on the field trip for the day can be aggregated and developed from the real time scan data entered into OBC 300. Accordingly, a driver of the vehicle may be notified if one or more riders do not return to his vehicle after a designated vehicle stop and disembarkation. Additionally, the remote server 1200 may be configured to transmit data to the OBC 300 to display and inform the driver whether the assigned scan data for his vehicle has been read by reader 330 for another OBC 300 on another vehicle, thus indicating that a rider assigned to one vehicle is actually on a different vehicle.

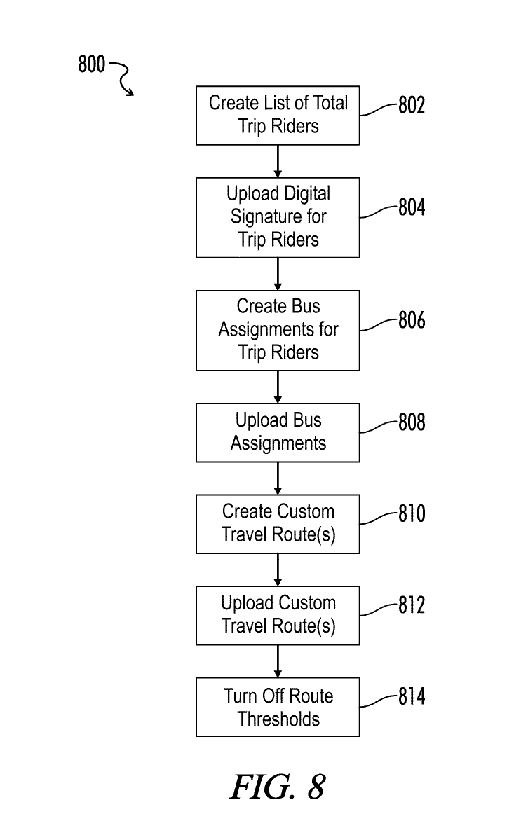

FIG. 8 depicts some example steps in flowchart 800 for creating pre-populated lists adapted for a modified palm scan search by the OBC 300. Clearly, one or more of the steps or operations may change in order or be combined with another operation. Initially, in one example embodiment, an authority figure such as a school administrator or trip planner creates (802) a list of total trip riders. It is contemplated that the list of trip riders already has existing digital signatures developed from their palm scans at the time of school enrollment or registration. With this in mind, the digital signatures for the listed trip riders are uploaded (804) to the remote server 1200 in order to pre-populate the searchable data for OBC 300. Likewise, the authority figure creates (806) bus assignments for trip riders. This particular authority figure may be different than the authority figure that created the list of trip riders. In some embodiments, the authority figure may comprise a control logic 1265. Nevertheless, each student is assigned a particular bus to ride during the field trip. When the student boards or leaves a bus, his or her palm scan will be searched for his or her assigned bus.

The newly created bus assignments are uploaded (808) to the remote server 1200. The bus assignments may also include information on specific drivers in addition to the assigned students for the buses. Therefore, after a particular driver starts the bus, the reader 330 reads palm scan and the processing element 312 determines whether the bus is properly assigned to him. The trip planner creates (810) custom travel routes for the bus. Additionally, more than one travel route may be created to account for traffic conditions, construction, or impending bad weather; and thereby uploaded (812) to the processing element 312, for example. Accordingly, the travel route may differ during the course of travel to and from the field trip's destination point. For example, there may be primary routes, secondary routes, and intermediary routes on the way to a designated location. Control logic 316 may automatically function in cooperation with location sensor 340 in an automated trip planner function.

During the course of travel, the OBC 300, when in field trip operational mode, may be instructed to disregard (814) previously described route thresholds used in normal operation mode, such as thresholds involving distance traveled by the vehicle and vehicle speed. This is in contemplation that when the OBC 300 is in field trip operational mode all rider scans will happen at one vehicle stop, rather than occurring in small groups of vehicle stops dispersed throughout the travel route. For example, at the start of the field trip, all students assigned to a bus with an OBC 300 will enter and scan their palms. Upon completion of scanning, the rider data for all of the students may be pushed all at once to the remote server 1200, rather than waiting for the bus to travel a certain distance interval or obtain a certain speed. However, in some embodiments, the control logic 316 may be configured to allow the push of rider data to happen only after the bus begins travelling on its route. In this case, an initial speed and distance threshold may still be employed, but no additional speed and distance thresholds would be necessary where, for example, the bus encountered traffic and traffic control signage along its route, which would necessarily affect the bus' speed.

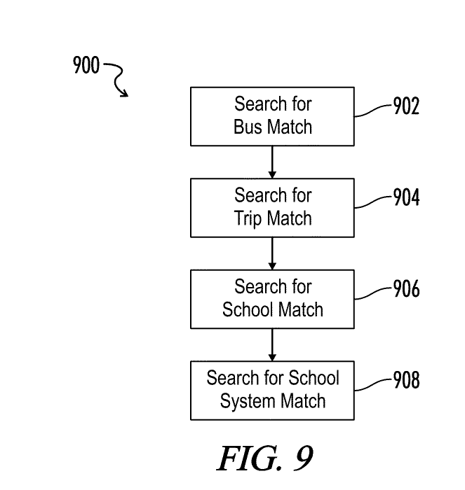

FIG. 9 depicts an example flowchart 900 for illustrating one example process, wherein the OBC 300 employs palm scan searching, according to control logic 316, as a student enters a bus designated for traveling to a field trip destination. The OBC 300 searches (902) for an assigned bus match with a digital signature from the palm scan of the student to determine whether the student has entered the correctly assigned bus. The OBC 300 also searches (904) for a match with the student and the field trip destination, according to control logic 316, to determine whether the student is authorized to travel to the field trip destination. The field trip destination may be located in memory 314 of the OBC 300 or alternatively at the remote server 1200. Location sensor 340 may inform processing element 312 when the vehicle reaches the field trip destination. Additional searching may be conducted by the OBC 300 where either of the matches for bus assignment and field trip destination is unsuccessful. For example, the OBC 300 searches (906) for a match with the school scheduled to attend the field trip and the student seeking to attend the field trip, in order to determine that the student is enrolled in the school. A wider search has the OBC 300 searching (908) for a match with the school system-wide enrollee list to determine whether the student is enrolled in one of the multiple schools within the school system, which may be city or county wide.

Therefore, in advance of travel on specially-assigned or custom travel routes, the OBC 300 may be modified to ensure that during the course of a field trip, for example, that each student traveling on the field trip is accounted for at each boarding and unloading of the bus or other designated vehicle. Accordingly, the OBC 300 is configured, according to control logic 316, to determine specific matching of who gets on and who gets off at a particular travel stop. To accomplish this, the OBC 300 is communicatively coupled to the remote server 1200 via network access device 350. As previously described, the whole school system's population, reflected by stored scan data at the remote server 1200, and transmitted to the OBC 300, for example, may be analyzed by the control logic 316 to determine whether a student got off one bus during the course of the field trip, but got on another bus after a travel stop, such as at the field trip's destination or end point or a scheduled stop in between. Hence, scanning of the students boarding and disembarking also makes it possible for accounting for the students at intermediate stops within the course of the field trip, such as for a lunch outing or dinner after a ball game. The display 360 may be configured by control logic 316 to notify the driver that specific students, assigned to his bus, have not scanned into reader 330 and thus are presumed absent from the bus. Alternatively, display 360 may also notify driver that a specific student who has scanned into reader 330 is not on the correct assigned bus.

Note that it is unnecessary for riders to be assigned a specific bus or other vehicle in any of the modes of operation. As an example, in the field trip operational mode, it is possible for the system to ensure that each student on a field trip has boarded a vehicle at a stop, such as the field trip destination or any point along the way. An example operation of the system for such an embodiment will be described in more detail below.

In this regard, at the beginning of a field trip or other event for which a group of vehicles are used to transport riders, control logic 1265 at the remote server 1200 is informed of which vehicles are to be used to transport riders. As an example, a user may provide an input identifying the vehicles to be used for the field trip. As the riders are boarding the vehicles, each rider scans his or her palm via the reader 330 of the vehicle on which he or she is boarding, according to the techniques described herein. For each scan, a notification identifying the scanned rider and the vehicle on which he or she has boarded is sent to the remote server 1200, and the control logic 1265 builds a passenger list indicative of each rider that boarded a vehicle for the field trip. If desired, the passenger list may correlate each rider with the vehicle on which he or she is riding. Accordingly, as the vehicles are traveling, the passenger list should identify each person who is riding on any of the vehicles, and the passenger list can be analyzed to determine which vehicles are transporting which riders.

At a vehicle stop, the riders scan their palms as they exit the vehicles, as described above. For each such scan, a notification identifying the scanned rider is sent to the remote server 1200, and the control logic 1265 updates the passenger list to indicate that the identified rider is no longer on one of the vehicles associated with the field trip.

At some point, the riders begin boarding the vehicles again. As riders board, they scan their palms. As described above, for each scan, a notification identifying the scanned rider and the vehicle on which he or she has boarded is sent to the remote server 1200, and the control logic 1265 updates the passenger list to indicate that the identified rider has boarded a vehicle. The control logic 1265 also updates the passenger list to indicate which vehicle the identified rider has boarded, noting that a given rider does not necessarily have to board the same vehicle that transported the rider to the stop.

Eventually, a determination is made that the boarding process is complete. Such determination can be made in various ways. As an example, a user may provide via the OBC 300 or otherwise an input indicating that the boarding process is complete, and the input may be transmitted to the remote server 1200. Alternatively, when a vehicle begins to move, as determined by the vehicle's location sensor 340 or otherwise, the vehicle's OBC 300 may transmit a notification to the remote server 1200 indicating the vehicle is leaving the stop. Based on such input, the control logic 1265 may determine that the boarding process is complete and, in response, perform an analysis of the passenger list to ensure that each rider on the list has boarded a vehicle associated with the field trip. In this regard, if all of the riders on the list have boarded a vehicle and scanned their palms as they boarded, then the passenger list should be updated to indicate that each rider is currently on a respective vehicle. However, if a rider fails to board the vehicle at the stop, then the passenger list should identify such rider but indicate that he or she is not currently on a vehicle (based on the rider's last scan as he or she exited the vehicle on which he or she was riding prior to the stop). If the control logic 1265 determines that the boarding process is complete and that the passenger list identifies a rider on the field trip who is not currently on a vehicle, then the control 1265 takes at least one action for warning at least one user of such event. As an example, the control logic 1265 may transmit a warning message to at least one OBC 300 or to a cellular telephone or other mobile device of at least one user on at least one vehicle. In response to such message, a person on the vehicle may then search for the missing rider thereby decreasing the probability that a rider will be inadvertently left at the vehicle stop.

Note that, if desired, the techniques described above for the field trip may be similarly used for each vehicle to ensure that each rider boards the same vehicle after each stop, rather than allowing riders to board any vehicle. In such an embodiment, a passenger list for each vehicle may be maintained similar to the passenger list described above in the previous embodiment. Each passenger list indicates which riders are assigned to the vehicle that is correlated with the list and indicates which riders are currently on such vehicle. Thus, before the vehicle leaves a stop, the passenger list may be analyzed to ensure that each rider assigned to the vehicle actually boarded the vehicle at the stop. If not, a notification message may be generated. In such an embodiment, the control logic 316 at the OBC 300 may be configured to manage the passenger list, since communication with the other OBCs 300 of other vehicles is unnecessary.

In addition, techniques similar to those described above for field trips may be used to ensure that a rider is not inadvertently left at a stop for other types of events, such as when a plurality of vehicles are chartered for trip to a ball game, concert, or other type event.

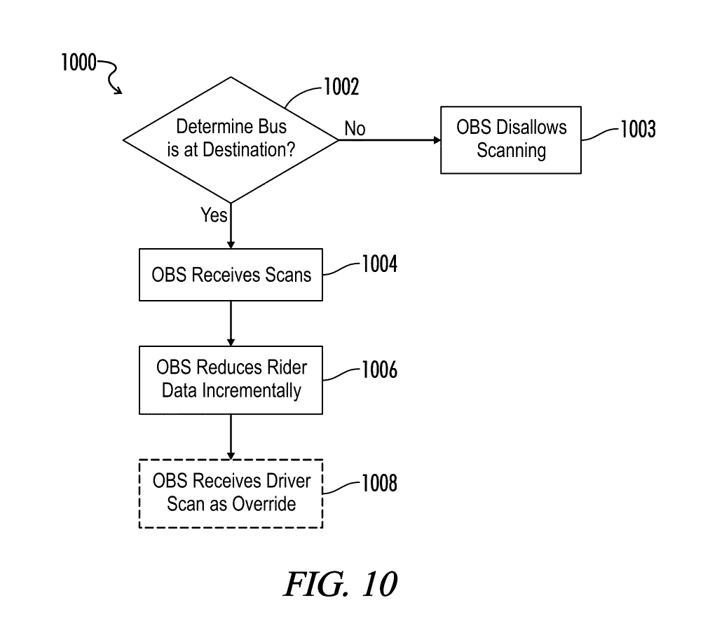

In the embodiments described above, riders scan their palm as they enter and exit a vehicle so that a real time determination can be made as to which riders are currently on which vehicles. FIG. 10 depicts an example exit scanning sequence for which a successful exit scan is allowed only if the vehicle is at a predetermined destination. The flowchart 1000 illustratively shows an example process for handling rider's scans as they exit a vehicle. Control logic 316 causes the processing element 312 to perform an initial determination (1002) about whether the vehicle is at its destination point using location data from location sensor 340. If the location sensor 340 provides location data that does not match the destination point, the control logic 316 of OBC 300 may disallow (1003) exit scanning by disabling reader 330, for example, in order to allow rapid exit from the vehicle in case of an emergency. In this regard, the OBC 300 may not be functional or operational for palm scan reading.

If the OBC 300 determines from its location sensor 340 that the vehicle is indeed stopped at its destination point, the OBC 300 receives (1004) rider's scans as they serially exit the vehicle. Thus, the OBC 300 is configured to operatively allow exit scanning once the destination point is reached. As each rider's palm scan is received by the OBC 300, logic 316 reduces (1006), incrementally, the rider data at the OBC 300. Thus, with each successful exit scan, the processing element 312 reduces the passenger list by one, until no passengers are left in or on the vehicle as evidenced by the exit scan at reader 330. In addition, to the processing element 312 decrementing the count or totality of passengers, the processing element 312 may employ data in memory 314 to assess the identification of riders exiting the vehicle.

Optionally, the OBC 300 may receive (1008) a driver's palm scan via a palm sensor 120 as an override mechanism where there appears to be an inconsistency between the OBC 300 and a physical confirmation check conducted by the driver regarding the presence of a student still in the vehicle. For example, if a student exits the vehicle without scanning his palm at the reader 330 of OBC 300, then the memory 314 of the OBC 300 retains the student's earlier entrance scan data and continues to register the student as being on the vehicle. However, the driver is obligated to conduct a physical search to ensure all students have left the vehicle. In another example, the driver conducts a physical check to confirm displayed information on display 360 of the OBC 300 informing the driver that the vehicle is empty of riders, except for the driver herself. Subsequently, the driver scans her own palm at reader 330 to automatically indicate to the OBC 300 that the vehicle's travel along the designated route has ended. The control logic 316 may cause the processing element 312 to assess the accuracy of the driver's scan data and thereafter shut down the network access device 350 and the display 360, for example.

In another embodiment, the processing element 312 registers the status of a person as unknown, based on inconsistent scan information received at reader 330. In this regard, a person may have previously scanned his palm at reader 330, but the processing element 312 and/or memory 314 of the OBC 300 may have lost track of the person once the driver scans his palm at the reader 330 when he terminates his route (i.e., an end of route palm scan by the driver). Accordingly, there will be a recordation of the rider's unknown location status sent to the remote server 1200 for further action, such as an authority figure confirming that the rider has left the vehicle and is present at a known location. In one embodiment, an additional reporting feature may include the remote server 1200 sending a text message to concerned parents and/or administrators, if the rider's location status changes.

The OBC 300 can be configured as a modular system, thus enabling it to work with another OBC on the same vehicle. For example, a second OBC may be placed at a second entry/exit point for the vehicle. Likewise, for extra-large vehicles, a third entry/exit point may exist and therefore a third OBC can be placed proximate to the third entry/exit point of the vehicle. Multiple readers 330 for sensing scan data associated with biometric scans, RFID scans, and NFC scans, for example, may be communicatively coupled to the microcontroller 310 (FIG. 3). In this regard, the microcontroller 310 may be able to discern which reader 330 received the scan by using information transmitted via system bus 325 to processing element 312 and/or network access device 350 for the several readers 330. Additionally, the components within the OBC 300 are easily replaceable, should a component fail. As such, the reader 330 can be replaced without replacing the microcontroller 310. Clearly, the microcontroller 310 may also be replaced without replacing the reader 330.

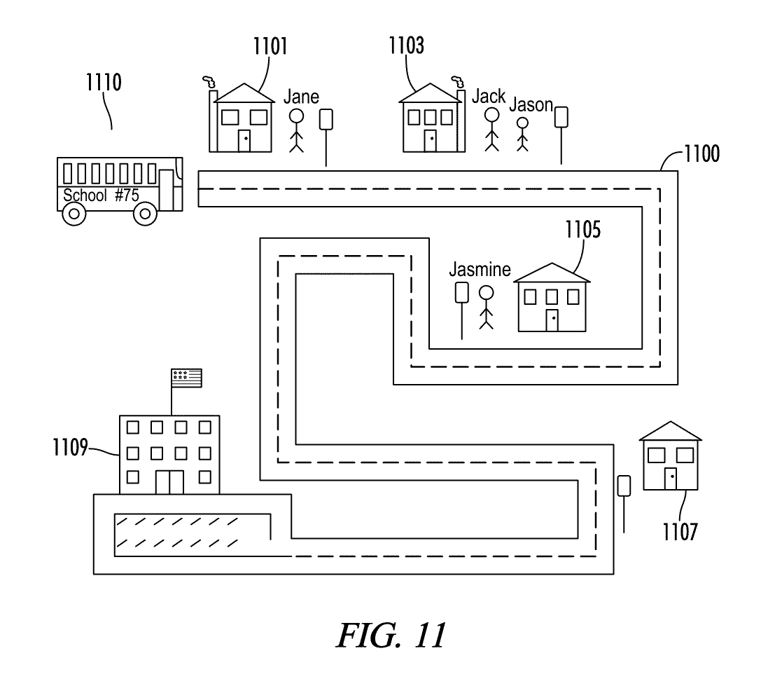

FIG. 11 depicts an example route 1100 for describing one or more embodiments. Route 1100 in this example is a school bus route, but need not be so limited. School bus 1110 has been assigned to route 1100 to make several stops to pick up several riders in order to transport the riders to school 1109. Before traveling route 1100, the driver of school bus 1110 scans her palm into the OBC 300 (FIG. 3) after initializing OBC 300. Her scan is confirmed as assigned to bus 1110.

School bus 1110 arrives at bus stop 1101 to pick up Jane. Upon entering bus 1110, Jane scans her palm into the reader 330 of OBC 300 to get confirmation, in a manner previously described above, that she is authorized to ride bus 1110. A visual notification and/or indicator from OBC 300 confirms Jane's school enrollment and authorized ridership. The bus 1110 travels a distance of X at a speed of Y to bus stop 1103. If distance X and speed Y are above the predetermined thresholds, Jane's scan data including her entry time and location of entry (i.e., rider data relevant to Jane) are pushed to remote server 1200 (described hereafter with reference to FIG. 12) from the OBC 300, if network access device 350 and processing element 312 cooperatively determine an available wireless network exists for the transmission.

School bus 1110 arrives at bus stop 1103 to pick up Jack and Jason. Upon entering bus 1110, Jason scans his palm into the reader 330 of OBC 300 to get confirmation that he is authorized to ride bus 1110. A visual notification and/or indicator from OBC 300 confirms Jason's school enrollment and authorized ridership. Jack also scans his palm into reader 330 of OBC 300, but does not get a displayed or audible confirmation for school enrollment (as an output from display 360 or speaker 370, respectively). However, he is given an authorized ridership, based on the information stored in the memory 314 of OBC 300, because his scan indicates that he resides in the school district and is a school-age brother of Jason. Both Jack and Jason also have scan data at the remote server 1200 acquired during enrollment/registration. The individual scan data may be categorized for siblings or other family members to provide additional criteria for scan approval and/or authorization by the processing element 312 of OBC 300. On the vehicle, both scans are initially read by reader 330 and analyzed by control logic 316 of the OBC 300, and subsequently pushed to the remote server 1200 when all predetermined criteria for distance traveled, vehicle speed, and network availability, for example, are met.

School bus 1110 continues travelling route 1100 to the next bus stop, bus stop 1105, to pick up Jasmine. Jasmine has to use a middle entry point for the bus 1110, so she scans her palm in a second reader 330 communicatively coupled to OBC 300 at the front of the bus 1110. Her ridership is authorized to school 1109 and also a subsequent day field trip once arriving at the school 1109. The bus 1110 continues to travel route 1100, including passing a non-approved bus stop 1107 (as designated and stored at remote server 1200 and transmitted to the processing element 312 via the network access device 350, because of a recently disciplined rider at bus stop 1107 has lost his or her riding privileges for the vehicle for a period of time). Suspended riderships and their impact on OBC 300 and remote server 1200 were described earlier herein.

The school bus 1110 arrives at the school 1109 and stops to allow the riders to exit. Each rider has to scan his or her palm before exiting. All riders do so, except Jack who rushes off to his own school. As a result of Jack failing to exit scan, the OBC 300 still registers Jack as being on the vehicle. However, the driver is obligated to conduct a physical search to ensure all students have left the vehicle. The OBC 300 can be configured to receive the driver's palm scan as an override mechanism where there appears to be an inconsistency between the OBC 300 and a physical confirmation check conducted by the driver regarding the presence of a student still on the vehicle.

Each compliant rider scans his or her palm, at reader 330, as he or she exits. Therefore, the OBC 300 receives each rider's palm scan and the control logic 316 reduces, incrementally, the rider data at the OBC 300. Thus, with each successful exit scan, the passenger list is reduced by one, until no passengers are left in or on the vehicle as evidenced by the exit scan. The driver's physical check confirms the electronic rider data reading from the OBC 300 that the vehicle is empty, except for the driver herself.

FIG. 12 depicts a block diagram for an example server system 1200. The server system 1200 includes at least a processing element 1240, which can be a digital signal processor (DSP) or a central processing unit (CPU) that communicates to and drives the other electronic components within the server system 1200 via a local interface, which can include at least one system bus 1242.

The processing element 1240 may be controlled with control logic 1265 to accomplish analytical and mathematical tasks for the server system 1200. The control logic 1265 can be implemented in software, hardware, firmware or any combination thereof. For the example processing element 1240, illustrated by FIG. 12, the control logic 1265 is implemented in software and is stored external to memory 1260 of the server system 1200. However, in other embodiments the control logic 1265 may be stored internal to memory 1260 of the server system 1200. Furthermore, the control logic 1265 may also be implemented by hardware such as application-specific integrated circuits (ASICS) or field programmable gate arrays (FPGAs) and reside external to the processing element 1240.

Note that the control logic 1265, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The memory 1260, which is also communicatively coupled to the system bus 1242, includes several types of data sets for storage related to the operation of the OBC 300 (FIG. 3). Specifically, bus assignment data 1252 can be included in the memory 1260 for storing particular relational assignment of third party vehicles to the drivers of the vehicles and expected riders of the vehicles. Likewise, enrollment data 1254 can be included in the memory 1260 for storing a list of authorized riders associated with a particular facility and/or system network. For example, an educational facility may have enrollment data about its students and faculty. A network of educational facilities can have multiple packages of enrollment data corresponding to each facility or unit.

Network device data 1256 can also be included in the memory 1260. Network device data 1256 may include protocols for communicating with external wireless devices, including each of the OBC 300 that reside on assigned vehicles. Failure rates and communication efficiency rates for the OBC 300 may also be contemplated as network device data 1256 and also stored in the memory 1260.

Another contemplated data set for storage in the memory 1256 is related to the “rider data” about individual riders of the vehicular transportation system, which may be stored as biometric sensor data, for example, in the memory 1256 for comparison with real time versions of the same in the OBC 300 on each vehicle. Stored rider data may include information about authorized riders or passengers for a specific vehicular transportation system, such as a district-wide school bus system, for example. The stored rider data may also include information about authorized riders for a particular vehicle in operation on a particular day, for example.

Within the server system 1200 are additional interfaces, coupled to the local interface 1242, for enabling communication with external devices. For example, an input interface 1244 can be provided for receiving input signals from input control devices such as keyboards, mice, and microphones. Likewise, an output interface 1246 may be provided as a means to communicate with display devices, headsets, and stand-alone speakers, for example. A network interface 1248 when coupled to the local interface 1242 provides a means to communicate wirelessly with external devices over a network, such as the Internet, using industry standard protocols (e.g., TCP/IP protocol). Additionally, the network interface 1248 may also be configured for WiFi protocols.

Upon completion of the push of the rider data from the OBC 300 to the server system 1200, the server system 1200 transmits a return acknowledgement to the OBC 300. When the server system 1200 successfully receives the transmission or push from the network access device 350 of the OBC 300; the server system 1200 sends the return acknowledgement. The server system 1200 updates the rider data and stores it in the memory 1260. The rider data may comprise several data components, including, for example, one or more bus assignments 1252, one or more records of enrollment data, and one or more sensor data 1258, such as from a palm vein reader 120.

In one embodiment, each updated rider data record can be serially received during a push from the OBC 300 to the server system 1200, if Internet access exists via network interface 1248. After each push, the network interface 1248 verifies availability of Internet access, as well as conducts a re-verification of the completed transmission of rider data received at the server system 1200. In one example, the network interface 1248 may send an indicator signal or bit, labeled as a true flag, to indicate that the transmission or push was successful. In contrast, where the transmission or push was unsuccessfully processed or incomplete, the network interface 1248 may send a false flag. A third scenario may comprise the network interface 1248 unable to send either a true or false flag, because too much time elapses within a defined time period, as tracked by clock 1250. In this last regard, the server system 1200 waits for a later transmission or push attempt by the OBC 300.

The server system 1200 also includes a clock 1250, which enables time-stamping of the data to be stored in the memory 1260. Additionally, clock 318 of OBC 300 utilizes processing element 1240 in cooperation with logic operations as determined by control logic 1265 for logical operations requiring time intervals, for example. Likewise, specific mathematical operations may be performed within time intervals based on values generated by the clock 1250.

All of the above described electronic components are cooperatively connected together to enable a rider to scan and authenticate his or her identification, store that authentication, link it to a GPS coordinate and timestamp, and push that information to the network accessible location where it can be viewed via a website application 1270.

The website 1270 may be accessed, for example, via a touch enabled graphical user interface (GUI). The GUI can be a part of the server system 1200 that school administrators use to view the rider data being collected on the bus, for example. In one illustrative embodiment, the GUI can be highly customizable for the end user, i.e., school administrators, to display ridership information, for example. Accordingly, the website 1270 can be configured to reveal the information relevant to the end user's requirements and can be adaptable to an organization in order to fit within their online and privacy procedures, for example. In addition, the website 1270 may be configured to generate specific ridership reports in desirable formats and presentation styles.

In one contemplated example embodiment, the website 1270 includes at least three parts (e.g., an enrollment GUI, a website shell, and mobile application software), configured for vehicle tracking and rider tracking. In one example embodiment, the website 1270 enables enrollment and verifies the vascular data of a student, driver, or other specified user; and assigns that set of vascular data to a particular school bus. Real time information is stored and communicated to the network accessible location.

Subsequently, a list of students currently on a bus and their relevant riding history, along with the real time location of the bus is displayed through the website. In addition, website 1270 is adapted to display when and where the student riders boarded and disembarked their bus. As such, bus location, “scan-ons”, and “scan-offs” are also instantly viewable. Moreover, an additional reporting feature may include a text message sent to concerned parents and/or administrators, if the student rider's location status changes.

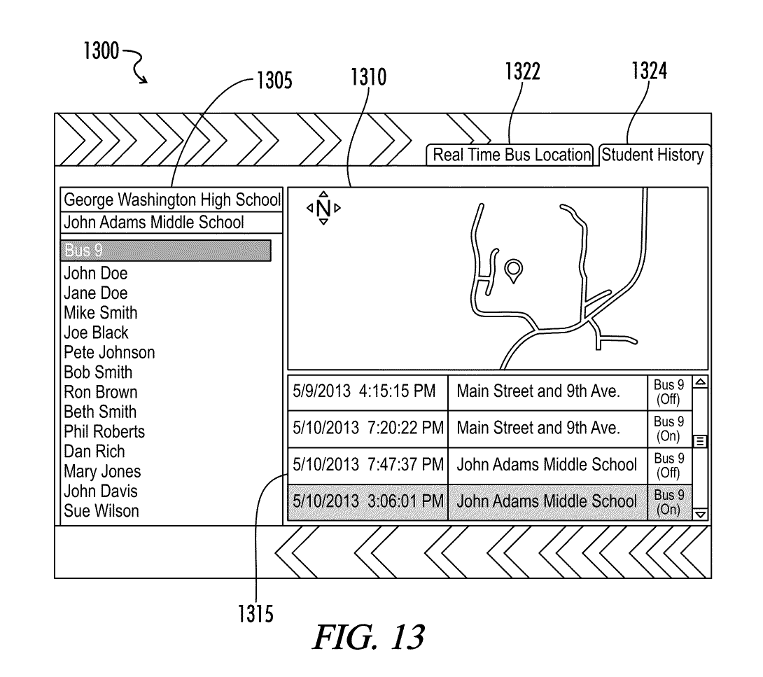

FIG. 13 depicts an example graphical user interface (GUI) 1300 that may be displayed to administrators and authorized users based on data transmitted from the OBC 300 to the remote server 1200. The GUI 1300 illustrates column 1305, which may include the name of schools a bus may travel to in order to provide transportation to students, for example. In addition column 1305 also includes a list of students on a particular as read and analyzed by OBC 300 in cooperation with the remote server 1200, according to the earlier detailed description herein. A portion of GUI 1300 includes a map 1310 that comprises a route and direction of the bus or vehicle. Another portion of GUI 1300 may comprise a schedule 1315 for the bus or vehicle, including timestamps, locations, and statuses for the bus or vehicle. The GUI 1300 can include additional information in a tabulated format comprising, for example a “Real Time Bus Location” tab 1322 and a “Student History” tab 1324. Other pertinent information can also be tabulated and is contemplated as within the scope of the disclosure.

Now, therefore, the following is claimed:

1. A system for tracking vehicle riders, comprising:
a plurality of on-board controllers (OBCs), each of the OBCs positioned on a respective one of a plurality of vehicles associated with an event and configured to sense when riders board and exit the vehicle on which the OBC is positioned; and
a remote server configured to communicate with the plurality of OBCs for determining which riders are on board the plurality of vehicles, the remote server configured to identify a plurality of riders on board the vehicles prior to the vehicles reaching a vehicle stop for the event, the remote server further configured to track which users exit and board the vehicles at the vehicle stop and to transmit a warning message in response to a determination that at least one of the plurality of riders failed to board any of the vehicles at the vehicle stop.

2. The system of claim 1, wherein one of the OBCs comprises a biometric reader for reading a biometric parameter of riders of the vehicle on which the one OBC is positioned, wherein the one OBC is configured store data indicative of the riders of the vehicle on which the one OBC is positioned, and wherein the one OBC is configured to wirelessly transmit the data from the vehicle to the remote server.

3. The system of claim 2, wherein the biometric read is configured to read palms of the riders of the vehicle on which the one OBC is positioned.

4. The system of claim 2, wherein the one OBC comprises a location sensor configured to determine a location of the vehicle, and wherein the data is indicative of the location.

5. The system of claim 2, wherein the one OBC is configured to transmit the data from the vehicle to the remote server in response to a determination that the vehicle is moving.

6. A system for tracking vehicle riders, comprising:
a reader positioned on a vehicle and configured to read a biometric parameter of riders of the vehicle;
a network access device positioned on the vehicle and configured to communicate with a network;
memory; and
control logic configured to identify the riders of the vehicle based on the reader and to store data indicative of the identified riders in the memory, the control logic further configured to wirelessly transmit the data from the vehicle via the network access device.

7. The system of claim 6, wherein the reader is configured to read palms of the riders.

8. The system of claim 6, further comprising a location sensor configured to determine a location of the vehicle, wherein the data is indicative of the location.

9. The system of claim 6, further comprising a clock configured to provide a timestamp indicative of when the reader reads the biometric parameter for one of the riders, wherein the data is indicative of the timestamp.

10. The system of claim 6, wherein the control logic is configured to determine when to transmit the data from the vehicle based on the location sensor.

11. The system of claim 6, wherein the control logic is configured to transmit the data to the remote server via the network access device in response to a determination that the vehicle is moving.

12. The system of claim 6, further comprising a remote server configured to receive the data, the remote server further configured to determine which riders are on the vehicle during a time period based on the data.

13. The system of claim 12, wherein the remote server is configured to transmit to the network access device biometric information associated with the riders, and wherein the control logic is configured to compare the biometric information to the biometric parameter sensed by the reader for the riders.

14. The system of claim 6, wherein the remote server is configured to identify a plurality of riders riding on a plurality of vehicles associated with an event prior to the vehicles reaching a vehicle stop for the event, wherein the remote server is configured to determine whether each of the plurality of riders boards at least one of the plurality of vehicles at the vehicle stop and to transmit a warning in response to a determination that at least one of the plurality of riders failed to board any of the plurality of vehicles at the vehicle stop.

15. A method for employing an on-board reader to control access to a vehicle, comprising:
reading a biometric parameter of riders of a vehicle via a reader;
identifying the riders of the vehicle based on the reading;
storing, in memory, data indicative of the identified riders;
wirelessly transmitting the data from the vehicle to a remote server; and
indicating via the remote server whether a person is on board the vehicle during a time period based on the data.

16. The method of claim 15, wherein the reading comprises reading palms of the riders of the vehicle.

17. The method of claim 15, further comprising:
determining whether the vehicle is moving; and
controlling a timing of the transmitting based on the determining.

18. The method claimed in claim 15, further comprising determining whether a speed of the vehicle exceeds a threshold, wherein the transmitting is based on the determining.

19. A method for tracking vehicle riders, comprising:
sensing when riders board a vehicle;
identifying the riders based on the sensing;
storing, in memory, data indicative of the identified riders sensing when the riders exit the vehicle at a vehicle stop;
updating the data based on the sensing when the riders exit the vehicle at the vehicle stop;
identifying at least one rider who failed to board the vehicle at the vehicle stop based on the data; and
transmitting a warning message in response to the identifying.

20. The method of claim 19, wherein each of the sensing steps is based on a reader positioned on the vehicle.

21. The method of claim 20, wherein each of the sensing steps comprises reading a biometric parameter of the riders.

22. The method of claim 20, wherein each of the sensing steps comprises reading palms of the riders.

23. The method of claim 20, further comprising:
associating a plurality of vehicles with an event; and
determining whether the at least one rider boarded any of the plurality of vehicles at the vehicle stop,
wherein the transmitting is based on the determining.
